(19) United States
(12) Patent Application Publication
(10) Pub. No.: US 2014/0358483 A1
(43) Pub. Date: Dec. 4, 2014

(54) Fishing Data System

(71) Applicant: Pure Fishing, Inc., Columbia, SC (US)

(72) Inventor: Joaquim da Rosa, Lexington, SC (US)

(21) Appl. No.: 13/907,805

(22) Filed: May 31, 2013

(51) Int. Cl. G06F 17/30; G01D 9/28; A01K 87/00; A01K 89/00; A01K 99/00; A01K 97/00

(52) U.S. Cl. CPC G06F 17/30312; A01K 99/00; A01K 97/00; A01K 87/007; A01K 89/00; G01D 9/28
USPC 702/188; 707/803

(57) ABSTRACT

An automated fishing data collection and processing system is provided that can automatically collect real-time data associated with the use of a rod and reel, in combination with real-time environmental and other data, and automatically record the data with minimal or no user input. Electronic components installed in, on, or with the rod and the reel automatically collect information, and automatically transmit the information via a wired or wireless means to a hand-held communication element, which in turn, combines the information with real-time environmental data and stores the information to a memory device, or transmits the information to a PC or cloud storage using a wired or wireless communication means to create a fishing log of data points. The fishing log can be stored in the hand-held communication element, PC, memory storage device, or cloud storage for access by the user or multiple users as permitted.

### BACKGROUND OF THE INVENTION

1. Field of the Invention

The present invention relates to fishing equipment, and an automated data collection and processing system associated therewith to enhance the sport of fishing. More specifically, the present invention relates to an automated data collection and processing system using sensor-containing fishing equipment that enhances the angler's skill and experience by monitoring and capturing how the angler uses equipment relative to real-time environmental information, translating and formatting the collected information, and exchanging the formatted information between any number of digital devices and device users. The collected data is analyzed and formatted into a user-friendly database that can be queried to, for example, provide recommendations on how, where, and when to use equipment, thereby increasing the probability of catching fish and allow the angler to repeat successful fishing experiences.

2. Description of the Related Art

Avid anglers have long been keeping fishing logs. The logs include personally experienced information of when and where fish are caught, what types of fish are caught, and how fish are caught. Additional observed or environmental information such as weather, tide, and moon phase may be noted in such fishing logs, as each can be important factors used to predict fish behaviors and feeding patterns. Such additional information is typically obtained from news publications, almanacs, handheld sensors, or as more currently available, electronic databases. These fishing logs are then maintained by the diligent angler and studied to maximize the probability of catching fish and allowing the angler to repeat successful fishing experiences.

However, personally maintained fishing logs are characterized by a number of data integrity and sufficiency problems. For example, data accuracy can be poor due to manual input, delays or other inaccuracies. Ideally, fishing log entries are entered as soon as the fish is caught or at the moment of data recognition, and are based upon accurate measurement techniques. However, it is not convenient nor is it always possible to carry and update a fishing logbook during a fishing trip. As a result, data entry is often recorded after the fish is caught or after the moment of data recognition and the accuracy of the data suffers. For example, if the data is entered much later, the accuracy becomes dependent upon the angler's memory.

Further, conventional fishing logs require the use of a number of additional information sources, including handheld sensors, which may provide incorrect information or which may be entered into the fishing log by the angler incorrectly. Such sources also may not be uniform between users, nor perform uniformly between locations or at different times.

Still further, conventional fishing logs do not permit the easy manipulation and formatting of data contained therein. Correlation analysis or other reports cannot be easily created through the use of such a conventional fishing log. Still further, such conventional fishing logs cannot be easily shared with other anglers, or cannot easily incorporate information or data from fishing logs of other anglers.

Accordingly, there is a need for a system and method to automatically collect and store such information that relies less upon human action, and process such information in an electronic format such that the data can be manipulated and shared with other anglers.

To address such needs for data collection, various sensing elements have been proposed for adaptation to fishing sports. For example, U.S. Pat. No. 7,021,140 proposed the use of one or more of an angular rate gyro and an accelerometer within the body of sporting equipment for detecting movement, movement speed and direction of the sporting equipment, including, for example, a fishing rod. The data collected is then used to analyze the three dimensional motion of the equipment. Other sensing elements that have been proposed for adaptation to fishing sports include those of U.S. Pat. Nos. 7,461,805; 7,559,499; and 7,905,440, which proposed the use of a fishing reel with a tackle depth measurement unit, measured via spool rotation detection, a tension detector, measured via torque applied to the spool, and a data transmission unit that wirelessly transmits depth information to an external unit. The external unit also receives water depth information of a fish finder, and provides a visual comparison of the values using a display. U.S. Pat. No. 7,523,882 proposed the use of both a fishing rod having an accelerometer for measuring movements of the fishing rod, and a fishing reel with a sensor to detect bail movement when casting, and further detect line rotation, and U.S. Pat. Nos. 6,584,722 and 6,758,006 proposed a module for attachment to a rod and reel, a rod sensor for detecting casting, and a fishing reel switch for detecting reel activity.

Various output elements have also been proposed for adaptation to fishing sports. For example, U.S. Pat. No. 6,851,636 proposed a fishing reel with a receiver to receive and display information, and U.S. Pat. No. 5,524,831 proposed a fishing reel with a line feed measurement unit and a display to notify a user of line feed. These systems rely upon electronics, such as those of U.S. Pat. No. 7,669,360 which proposed a fishing lure with an encapsulated electronic circuit for detecting a fish strike and in response, measuring and storing other data associated with ambient conditions at the time of detection, and those of U.S. Pat. Nos. 5,131,165; 4,752,878 and 4,697,758 proposing sensors adaptable to rod and reels which can measure rod angles, line deflection angles and line extension lengths, and process the information for fishing control systems.

Various recordation systems have also been proposed for adaptation to fishing sports. For example, U.S. Pat. No. 6,222,449 proposed a remote data logging unit which can include sensors for detecting and recording environmental conditions, and an input mechanism to allow an angler to electronically enter and record other fishing data, all at a remote location, and store the recorded data to a central repository. A personal log can then be created based on the recorded data, and the data of multiple units can be compiled to share recorded data, and each remote unit can request such shared data while at a remote location for consideration by an angler. However, all of these systems still describe the need for significant manual data input and manual data manipulation, such that the accuracy remains dependent upon the angler's memory and entry accuracy. Further, these systems rely upon sources that may not be uniform between users, nor perform uniformly between locations or at different times.

Despite these teachings, there has not yet been a commercially viable system and method, and associated fishing equipment, for the automatic capture of data and creation of fishing log entries as soon as the fish is caught or at the moment of data recognition, based upon accurate and consistent measurement techniques, and which permits the easy manipulation and formatting of data contained therein, the merging of information from other anglers, and the ability to share that information with participating anglers.

### SUMMARY OF THE INVENTION

Accordingly, exemplary embodiments of the present invention address the above and other issues, and provide a fishing data collection and processing system for monitoring and automatically capturing equipment use data (EUD) in combination with real-time environmental data (RED), translating and formatting the collected information, and exchanging the formatted information between devices.

Another aspect of exemplary embodiments of the present invention is to provide data collection subsystems for monitoring and automatically capturing equipment use data (EUD) including, but not limited to, casting distance, casting direction, depth, retrieval speed and fish-on detection.

Another aspect of exemplary embodiments of the present invention is to provide data collection subsystems for monitoring and automatically capturing real-time environmental data (RED) including, but not limited to, GPS location, date, time, weather conditions, water conditions, moon phase, and tide (when applicable).

Another aspect of exemplary embodiments of the present invention is to provide data collection subsystems for monitoring and automatically capturing other data (OD) including, but not limited to, lure use, fish species and photographic information with or without geo-tagging.

Another aspect of exemplary embodiments of the present invention is to provide output subsystems for translating and formatting the collected equipment use data (EUD), real-time environmental data (RED), and other data (OD), displaying the formatted information in a user-friendly format, and exchanging the formatted information between devices.

To substantially achieve these and other aspects of the present invention, an automated fishing data collection and processing system is provided that can monitor and automatically capture equipment use data (EUD) from one or more of the rod and reel in combination with real-time environmental data (RED) and other data (OD), and automatically record the data with minimal or no user input. Electronic components installed in, on, or with the rod and the reel automatically collect equipment use data (EUD) such as the number of casts, casting distance, direction of cast, lure depth, lure retrieval speed, and when a fish is caught (e.g., fish-on information), and automatically transmit the information via a wired or wireless means to a hand-held communication element, which in turn, automatically combines the information with real-time environmental data (RED) such as GPS location, date, time, weather conditions, water conditions, moon phase, and tide. The data can be further combined with other data (OD) such as lure use, fish species and photographic information. The automated fishing data collection and processing system stores the information to a memory device, or transmits the information to a PC or cloud storage using a wired or wireless communication means to create a fishing log which can be stored in the PC, memory storage device, or cloud storage for access by the user or multiple users as permitted.

### BRIEF DESCRIPTIONS OF THE DRAWINGS

These and other objects, advantages and novel features of the invention will become more readily appreciated from the following detailed description when read in conjunction with the accompanying drawings, in which:

FIG. 1 is a view of an automatic fishing data collection and processing system for monitoring and automatically capturing equipment use data (EUD), combining the equipment use data (EUD) with real-time environmental data (RED) and other data (OD), translating and formatting the collected data, and exchanging the formatted data between devices in accordance with an embodiment of the present invention;

FIG. 2 is a view of a data collection subsystem for monitoring and automatically capturing real-time environmental (RED) data in accordance with an embodiment of the present invention;

FIG. 3 is a view of a data collection subsystem for monitoring and automatically capturing real-time rod and reel equipment use data (EUD) in accordance with an embodiment of the present invention;

FIGS. 4A, 4B, 4C and 4D are graphic views of some illustrative collected information in accordance with an embodiment of the present invention;

FIGS. 5A, 5B and 5C are graphic views of some illustrative statistical analysis outputs in accordance with an embodiment of the present invention;

FIG. 6 is a view of a data processing and output subsystem for translating and formatting the collected information in accordance with an embodiment of the present invention;

FIG. 7 is a view of a data processing and output subsystem for exchanging the formatted information between devices in accordance with an embodiment of the present invention; and

FIG. 8 is a flow chart of an exemplary operation of the automatic fishing data collection and processing system of FIG. 1 in accordance with an embodiment of the present invention.

Throughout the drawings, like reference numerals will be understood to refer to like parts, components and structures.

### DETAILED DESCRIPTION OF EXEMPLARY EMBODIMENTS

As shown in the attached figures, exemplary embodiments of the present invention provide an automated data collection and processing system to enhance the sport of fishing. More specifically, the exemplary embodiments provide an automated data collection and processing system that enhances the angler's skill and experience by monitoring and automatically capturing how the angler uses equipment relative to real-time environmental information and other data, translating and formatting the collected information, and exchanging the formatted information between digital devices and device users. The collected data is analyzed and formatted into a user-friendly database to provide recommendations on how, where, and when to use equipment, thereby increasing the probability of catching fish and allowing the angler to repeat successful fishing experiences.

Specifically, fishing equipment comprising at least a rod and reel work in conjunction with one or more of real-time, data capturing electronics, a triggering device and a hand-held or similar user receiver such as a smart phone to automatically record data. Electronic components are installed in or with one or more of the rod and reel to automatically collect equipment use data or information (EUD) such as the number of cast, casting distance, direction of cast, lure depth, lure retrieval speed, and when a fish is caught. The electronic components of the rod and reel automatically transmit the information via a wired or wireless means to the hand-held device, which in turn, transmits the information to a PC or other cloud storage and processing. Additional real-time environmental data or information (RED) available through the internet, sensors or other inputs, such as date, time, location, weather, water condition, moon phase, tide, and so forth, is also automatically collected by the hand-held device, PC or other cloud storage and processing, and is attached to or combined with the equipment use information (EUD) at any of the hand-held device, PC or cloud storage and processing, thereby forming a data point. The data points can further comprise other data or information (OD) such as lure use, fish species and photographic information, but embodiments are not required to do so. That is, the other data (OD) can also be attached to or combined with the real-time environmental data (RED) and the equipment use information (EUD) at any of the hand-held device, PC or cloud storage and processing, thereby forming a data point. A collection of data points can then be used to create a fishing log which is stored in the hand-held device, PC or cloud storage.

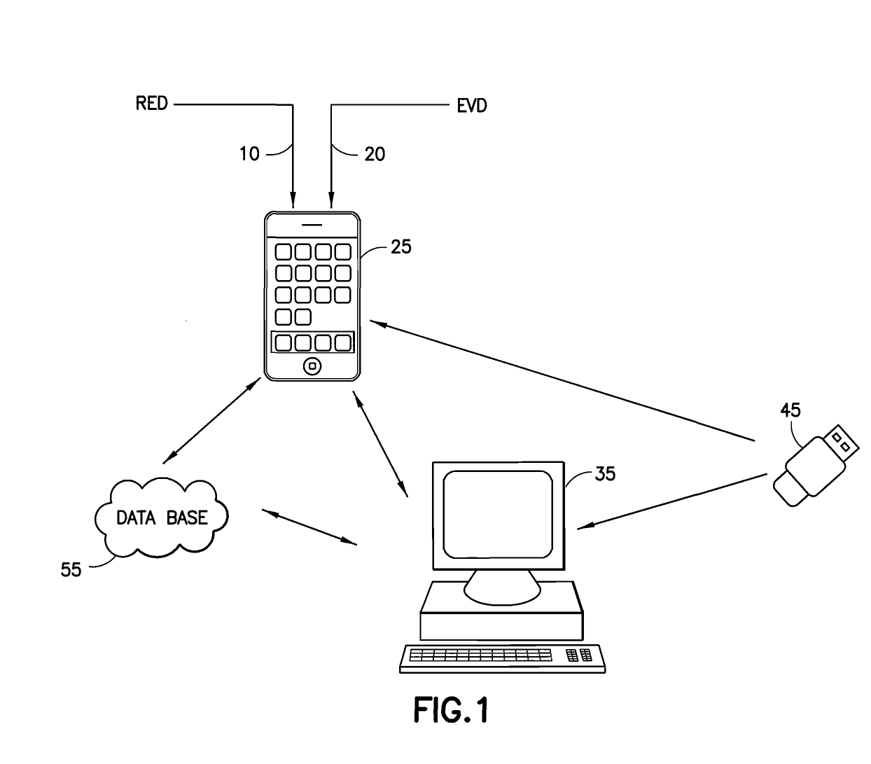

FIG. 1 is a view of an automatic fishing data collection and processing system for monitoring and automatically capturing equipment use data (EUD) and additional real-time environmental data (RED), automatically combining the equipment use data with the real-time environmental data and optional other data (OD), translating and formatting the collected data, and exchanging the formatted data between devices in accordance with an embodiment of the present invention. To do so, the system of FIG. 1 automatically collects inputs of data collection subsystems for monitoring and capturing equipment use data (EUD) and real-time environmental data (RED), and data processing and output subsystems for translating and formatting the collected information, storing the formatted information, and exchanging the formatted information between devices and users. In the exemplary embodiments of the present invention, the automatic fishing data collection and processing system is configured to automatically collect data inputs 10 and 20 at a wired or wireless user receiver or hand-held communication element 25, such as a cellular telephone, programmable cellular telephone, computer, receiver associated with a retransmitter, smartphone, or personal digital assistant (PDA). Other examples of a wired or wireless user receiver or hand-held communication element 25 can include but are not limited to an iphone™, android™, ipad™, blackberry™, or the like. The hand-held communication element 25 can further include GPS and Global Information Systems (GIS) technologies, as well as a keypad, digital camera and memory. As described in greater detail below, the hand-held communication element 25 includes wired and/or wireless communication technologies to exchange data with electronic components of the one or more rod and reels, and other system elements.

Other elements of the automatic fishing data collection and processing system include, but are not limited to a personal computer (PC) 35, and data storage device 45. Further, such elements can be replaced in part by, or supplemented with internet-accessible storage and computing elements 55. Bidirectional communication between elements 25, 35, 45 and 55 can be provided via any number of wired communication means such as USB and Firewire connections, and wireless communication means such as RF, Bluetooth and infrared communication, and others as specified under the IEEE 802 wireless standards, including but not limited to 802.11 (WiFi, WLAN), 802.15 (WPAN, Bluetooth, ZigBee) and 802.16 (WMAN). The hand-held communication element 25 can also include an internet browser to access the internet and download information to complete data points, and upload data points to be stored in a database, such as cloud storage.

Cloud storage is a model of networked online storage where data is stored in virtualized pools of storage which are generally hosted by third parties. Hosting companies operate large data centers, and people who require their data to be hosted buy or lease storage capacity from them. The data center operators, in the background, virtualize the resources according to the requirements of the customer and expose them as storage pools, which the customers can themselves use to store files or data objects. Physically, the resource may span across multiple servers. The safety of the files depends upon the hosting websites. Cloud storage services may be accessed through a web service application programming interface (API), a cloud storage gateway or a Web-based user interface. In the case of the present invention, cloud storage of data allows the user and others the ability to view and access the collection of data points and any digital fishing logs based thereon.

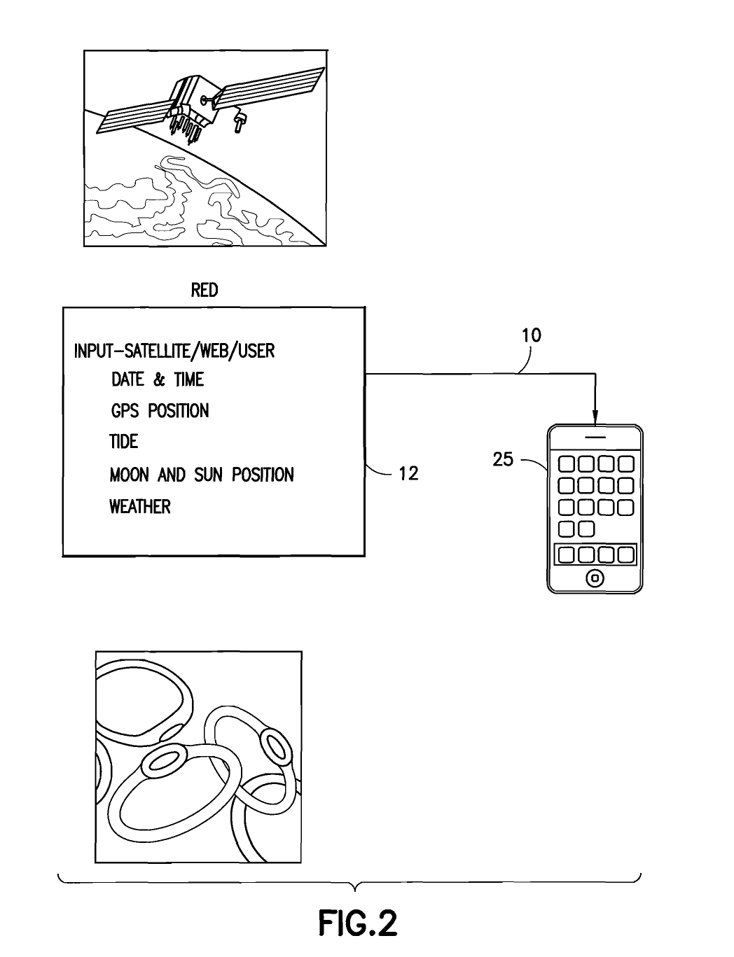

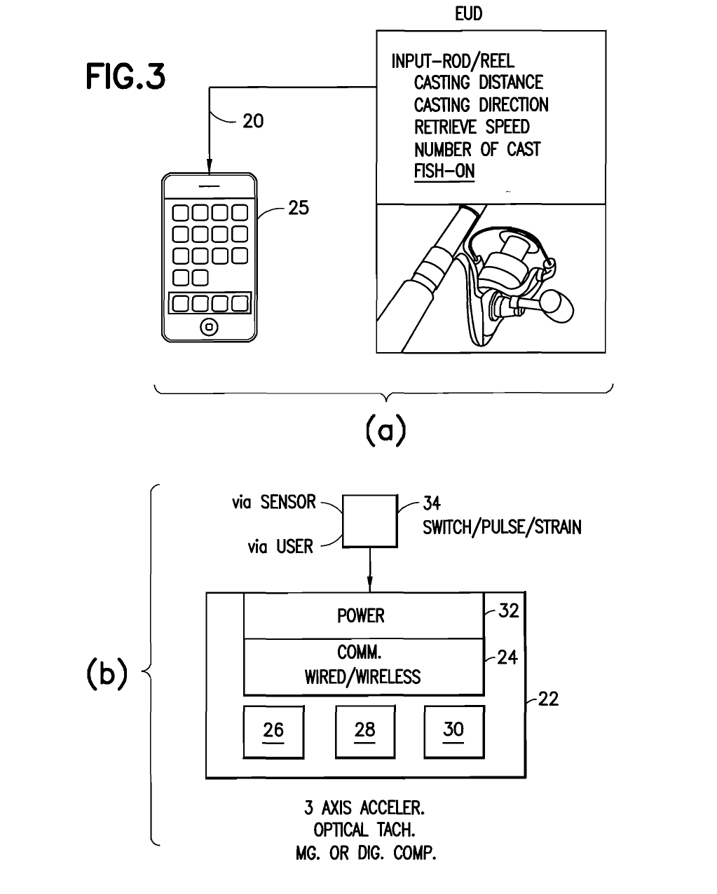

As briefly noted above, the automatic fishing data collection and processing system is configured to automatically collect data inputs 10 and 20 from data collection subsystems wherein such subsystems are configured for monitoring and capturing equipment use data (EUD) and real-time environmental data (RED). For example, input 10 of real-time environmental data (RED) can be provided by the subsystem of FIG. 2, and input 20 of real-time equipment use data (EUD) can be provided by the subsystem of FIG. 3.

The subsystem of FIG. 2 automatically collects and provides real-time environmental data (RED) inputs from sources such as satellites, Web, internet or other such sources. Examples of such real-time environmental data (RED) include, but are not limited to date and time, GPS position, tide, moon and sun information, weather (i.e., temperature, rainfall, and wind and barometric pressure) and water conditions (i.e., temperature, clarity and level). The subsystem of FIG. 3 automatically collects and provides real-time equipment use data (EUD) inputs from sources such as the rod and reel being used. Examples of such real-time equipment use data include, but are not limited to casting distance, casting direction, lure depth, retrieval speed, cast number and fish-on information. The subsystems of FIGS. 2 and 3 are shown separately in the exemplary embodiment of the present invention but are not limited thereto. In this or other exemplary embodiments of the present invention, the subsystems of FIGS. 2 and 3 can be combined.

The hand-held communication element 25 can automatically access the subsystems of FIGS. 2 and 3 via wired or wireless communication means such as RF, Bluetooth and infrared communication, and others as specified under the IEEE 802 wireless standards, including but not limited to 802.11 (WiFi, WLAN), 802.15 (WPAN, Bluetooth, ZigBee) and 802.16 (WMAN). The real-time equipment use data (EUD) and environmental data (RED) can be automatically updated and communicated to the communication element 25 continuously and/or at set time intervals, at set distance intervals, or can be automatically updated and communicated to the communication element 25 at the occurrence of a triggering event as described in greater detail below. The communication element 25 can further receive or capture other data (OD) including but not limited to photographic information with or without geo-tagging, and lure information via wired or wireless communication or direct user input, but which is not required for operation of the present invention. To do so, the communication element 25 can further comprise a digital camera, touchscreen and/or keypad for entry and capture of such other data (OD) information.

In regard to the subsystem of FIG. 3, view (a) illustrates a rod and reel 14 provided with one or more electronic sensors, trigger-detection elements and communication elements as illustrated in the block diagram (b), that work in conjunction with the communication element 25 to automatically record fishing and equipment use data from at least one of the rod and reel. Electronic components are installed in or attachable to one or more of the rod and reel to automatically collect equipment use information such as the number of cast, casting distance, direction of cast, lure depth, lure retrieval speed, and when a fish is caught. One or more of the rod and reel 14 automatically transmit the information via wired or wireless means to the communication element 25, which in turn, automatically transmits the information to a PC or other cloud storage and processing.

The rod and reel 14 are provided with a number of real-time, data capturing electronics 22 and can work in conjunction with other devices, such as a triggering device 34, and the communication element 25, to automatically record real-time fishing and equipment use data. The electronic components can be installed in the rod, reel, or both in some combination, to automatically collect information such as directional information, the number of casts, casting distance, the direction of the cast, lure depth and retrieval speed, and when a fish is caught (e.g., fish-on information).

In a first exemplary embodiment, the real-time, data capturing electronics 22 include a three-axis accelerometer 26, optical tachometer 28 and magnetometer 30 provided with the fishing reel. In a second exemplary embodiment, a three-axis accelerometer 26 and magnetometer 30 are provided with the fishing rod, and a magnetic element is provided with the reel. Where desirable to do so, an electric or digital compass can also be provided.

As known to those skilled in the art, an accelerometer is a device including, for example, a mass and spring such that when the accelerometer experiences an acceleration, the mass is displaced to the point that the spring is able to accelerate the mass at the same rate as the casing. The displacement is then measured and, using piezo-electric, piezo-resistive and capacitive components, is converted into an electrical signal. An optical tachometer is a device for measuring the rotation speed of a shaft or disk, as in a motor or other machine. To do so, a tachometer spindle is connected by an axle to a rotating magnet that induces a changing magnetic field upon a Hall effect transistor. Other systems connect the spindle to a stroboscope, which alternates light and dark upon a photodiode. A magnetometer is a device used to measure the strength or direction of a magnetic field, either produced in the laboratory or existing in nature, and includes scalar magnetometers that measure the total strength of the magnetic field to which they are subjected, and vector magnetometers that measure the component of the magnetic field in a particular direction, relative to the spatial orientation of the device. To do so, vector magnetometers electronically measure one or more components of the magnetic field using three orthogonal magnetometers, such that both azimuth and dip (inclination) can be measured.

The real-time, data capturing electronics 22 further can include wired and wireless communication system 24, memory and rechargeable battery power supply 32, within the rod, the reel, or both in some combination, or removably attachable thereto for detecting movement, movement speed and direction of the rod and reel during use. The captured data can be used to analyze and determine the three dimensional motion, position and other use of the rod and reel. The real-time, data capturing electronics 22 can be integral with the rod, insertable within a space provided within an opening of the rod, the reel, or both in some combination, or attachable to the rod or the rod and reel 14, separately or in combination, or can be provided as a removable module that can be moved between rod and reel outfits.

In the first exemplary embodiment, the three-axis accelerometer, optical tachometer and magnetometer are provided with or attachable to the fishing reel. The three-axis accelerometer is configured to detect and provide information regarding movement of the rod and reel, which can be used to calculate casting and casting distance and fish-on occurrences. The optical tachometer is configured to detect and provide information regarding movement of the line, line spool or reel handle, which can be used to calculate line feed amount and line retrieval rates, and the magnetometer is configured to detect and provide information regarding rod direction which can be used to calculate casting direction. In this embodiment, the electronics are configured for incorporation with, or attachment to the reel, but are not limited thereto.

For example, in the second exemplary embodiment, a three-axis accelerometer and magnetometer are provided with or attachable to the fishing rod, and a magnetic element is provided with the reel. The function of the three-axis accelerometer and magnetometer are as described above in regard to the first embodiment, but the magnetometer further senses the magnetic element provided with the reel. In the second embodiment, an optical tachometer can be omitted and replaced with functions of the magnetometer and a magnetic element provided with or attachable to the fishing reel. To collect line feed and retrieval rate information, a reel spool or handle is provided with the magnetic element. The rotational movement of the handle and magnet element therein creates a periodic disruption of a magnetic flux which is picked up by the magnetometer and is used to detect and communicate data which can be used to calculate line feed amount and line retrieval rates.

Further, the first and second exemplary embodiments of the present invention can include a sensor (not shown) provided with or attachable to the fishing reel to detect each cast based upon a detected activation of the fishing reel. As known to those skilled in the art, a cast can be initiated by pressing a button or lever, or flipping a bail, depending upon fishing reel construction. In each case, an additional sensor such as a magnetic sensor, optical sensor, or other switch, can be provided with or attachable to the rod, the reel, or both in some combination, or provided with or attachable to the rod and reel, to detect each cast. As noted in greater detail below, the detection of each cast can trigger the collection of data and creation of a data point.

To provide the wired or wireless communications between the rod and reel and the communication element 25, a telecommunications system and memory 24 (e.g. radio transmitters and receivers, remote controls, computer networks, network terminals, etc.) can be provided to store, buffer and transfer information with or without the use of wires using RF, Bluetooth and infrared communication, and others as specified under the IEEE 802 wireless standards, including but not limited to 802.11 (WiFi, WLAN), 802.15 (WPAN, Bluetooth, ZigBee) and 802.16 (WMAN). In yet other exemplary embodiments of the present invention, wired communication means can be used such as USB and Firewire connections. A rechargeable and/or replaceable battery or other power source 32 can be provided with at least one of the rod and reel to energize the sensors, data collection and the wired or wireless data communication.

The electronic components described above can automatically transmit the information via the wired or wireless means 24 to the communication element 25, which in turn, can store the information to the data storage device 45 such as, for example, a memory card, flash card or memory stick, or can transmit the information to the PC 35 or the cloud storage/processing 55 using a wired or wireless communication means of the communication element 25 including RF, Bluetooth and infrared communication, and others as specified under the IEEE 802 wireless standards, including but not limited to 802.11 (WiFi, WLAN), 802.15 (WPAN, Bluetooth, ZigBee) and 802.16 (WMAN), and wired communication means such as USB and Firewire connections. At one or more of the communication element 25, PC 35, or cloud storage/processing 55, the collected information can be combined in any number of fashions, such as the combination of the real-time environmental data (RED) such as date, time, GPS location (i.e., latitude, longitude and altitude), weather conditions, moon phase, water conditions, tide and so forth, with equipment use data (EUD) such as number of casts, casting distance, direction of the cast, lure depth and retrieval speed, and when a fish is caught, in real-time, thereby forming a data point. The other data (OD) can also be combined with data (EUD) and (RED), including but not limited to photographic information with or without geo-tagging and lure information, but which is not required for operation of the present invention. A collection of data points can then be used in a number of ways, such as the creation of a real-time, digital fishing log which can be stored in the communication element 25, PC 35, data storage device 45, and/or cloud storage/processing 55 in a similar manner.

In the exemplary embodiments of the present invention, at least one of the rod and reel are constructed with the electronic sensors, removable electronic modules, or some combination thereof, which can be easily transferred from one rod and reel set to another. The preferred electronic sensors perform at least the above described automatic data collection and transmission of the collected data to the hand held device or communication element 25, and provide a memory to store data until the data is transmitted to the hand held device or communication element 25. The rechargeable and/or removable battery can be included to provide power to the electronic components.

Still further, the first and second exemplary embodiments of the present invention can include an element 34 to detect a fish-on occurrence. A fish-on occurrence can be detected at element 34 by detection of one or more conditions such as rapid rod movement, rapid cessation of line retrieval with possible reverse line movement, and/or an increase in rod and/or line tension. A fish-on occurrence can also be detected at element 34 by a user input signal. In each case, the above sensors 26, 28 and 30 can be configured to provide these conditions or combination of conditions to element 34, or an additional sensor or switch can be provided with or attachable to the rod, the reel, or both in some combination to provide a trigger signal to element 34, to detect each fish-on condition at element 34. As noted in greater detail below, the detection of each fish-on occurrence can trigger the automatic collection of data and creation of a data point related to the fish-on occurrence.

For example, least one of the rod and reel 14 can be constructed or otherwise provided to employ the sensors or switch to sense the time a fish is caught (e.g., fish-on occurrence) using either a manual operation, automatic operation, or a combination of automatic and manual operations, and trigger the collection of data at the specific time of the fish-on occurrence. In doing so, the actual location where a fish is caught can be calculated using the time of triggering to gather at least a GPS position of the rod, directional (i.e., polar coordinate) information including the pointing direction and angle of the rod, and how much line is extended from the reel, to determine an exact position of the lure when the fish is caught, including lure depth.

However, as fishing is an enjoyable activity, and it is exciting when a fish is caught, a manual triggering system to detect this occurrence may be overlooked. Therefore, a third exemplary embodiment of the present invention provides for the automatic triggering of the detection of this occurrence. As noted above, the first and second exemplary embodiments of the present invention include the above sensors 26, 28 and 30 which can be configured to detect the conditions of a fish-on occurrence. For example, the vibration output from the accelerometer can be used to detect each fish-on occurrence. The sensors 26, 28 and 30 can be configured to provide these conditions or combination of conditions to element 34 to detect each fish-on condition.

An additional sensor (not shown) can also be proved and configured to provide conditions or combination of conditions to element 34 to detect each fish-on condition. For example, in the third embodiment of the present invention, the sensor can comprise a pulse monitor that can be used to detect changes in user pulse rates to automatically detect each fish-on occurrence. That is, in addition to the conditions noted above, the rapid rod movement, cessation of line retrieval, reverse line movement, and/or increase in rod or line tension, other fish-on conditions can include physiological conditions of the user such as an increase in the angler's heart rate. A pulse monitoring device can be worn either across the wrist or over the chest, and can be coupled with or wirelessly communicate with the real-time, data capturing electronics 22 or directly with the communication element 25. Where such a pulse-monitoring device is provided, the device preferably monitors a change of heart rate to detect each fish-on occurrence and trigger the system to record data at precisely the moment the fish is caught, a strike occurs, or simply when a fish is spotted, including at least GPS position of the rod, directional (i.e., polar coordinate) information including the pointing direction and angle of the rod, and how much line is extended from the reel, to determine an exact position of the lure when the fish is caught, including lure depth.

In a fourth exemplary embodiment of the present invention, the sensor or switch can comprise a manual triggering device which can be activated by the angler at each fish-on occurrence and trigger the system to record data at precisely the time a fish is caught, a strike occurs, or simply when a fish is spotted, including at least GPS position of the rod, directional (i.e., polar coordinate) information including the pointing direction and angle of the rod, and how much line is extended from the reel, to determine an exact position of the lure when the fish is caught, including lure depth. As noted above, a switch can be provided with or attachable to the rod, the reel, or both in some combination to provide a trigger signal to element 34, to detect each fish-on condition at element 34. The manual triggering device can comprise an electrical switch or button on one or more of the rod and reel, the communication element 25, or provided as a separate external button to trigger the system to record the data. The manual triggering device also allows the angler to confirm if a fish is caught, a strike occurred, or simply that a fish was spotted. For example, if the button is depressed when there is no line out or no cast has been detected, the system can note this and the manual triggering device can simply record the GPS position or can use the last known data (i.e., direction and maximum line out) to create a data point even in the case of missing, partial or unclear data.

In a fifth exemplary embodiment of the present invention, the sensor can comprise a strain gauge (not shown) to detect, for example, a sudden increase in deflection of the rod and/or an increased tension in line extending from the reel or in the rod to detect each fish-on occurrence and trigger the system to record data at precisely the time a fish is caught or a strike occurs, including at least GPS position of the rod, directional (i.e., polar coordinate) information including the pointing direction and angle of the rod, and how much line is extended from the reel, to determine an exact position of the lure when the fish is caught, including lure depth.

As noted above, the communication element 25 can store the information to the data storage device 45, or can transmit the information to the PC 35 or the cloud storage/processing 55 using a wired or wireless communication means. The information includes equipment use data (EUD) regarding the number of casts, casting distance, the direction of the cast, lure depth, lure retrieval speed, and when a fish is caught (e.g., fish-on information), real-time environmental data (RED) regarding GPS location, date, time, weather conditions, water conditions, moon phase, and tide, and other data (OD) regarding the lure use, fish species and photographic information with or without geo-tagging. The other data (OD) regarding the lure use can be input using RFID tagged lures or lures having bar codes or other identification marks, and providing the communication element 25 with an RFID interrogator or scanner.

The equipment use data (EUD) (i.e., the number of casts, casting distance, the direction of the cast, lure depth, lure retrieval speed, and when a fish is caught is automatically captured and combined with the real-time environmental data (RED) (i.e., GPS location (i.e., latitude, longitude and altitude), date, time, weather conditions, water conditions, moon phase, and tide), and with the optional other data (OD) (i.e., lure use, fish species and photographic information), thereby forming a data point. Where data is missing or where insufficient data has been collected to know a value, past values, averages or expected values can be used to create a data point. For example, cast distance may not be known with certainty until retrieval is completed, especially in the case where line is pulled from the reel by a fish. In this case, data of past casts or averages of past casts can be used to create a temporary data point, that can be replaced with a permanent data point when the missing information is received, or which can simply be made a permanent data point.

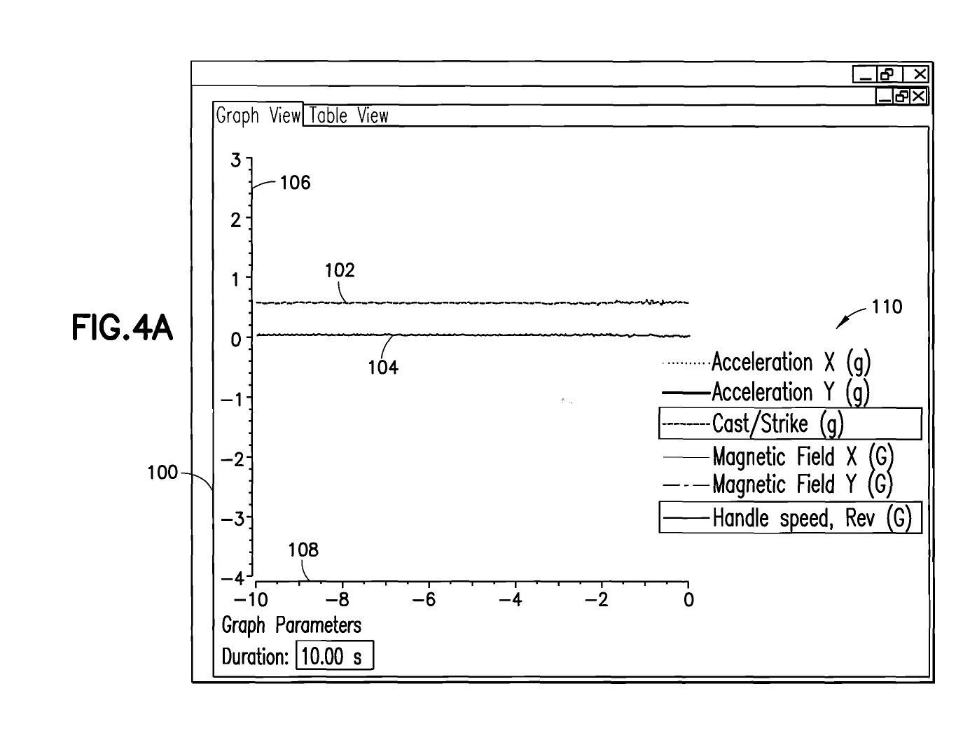

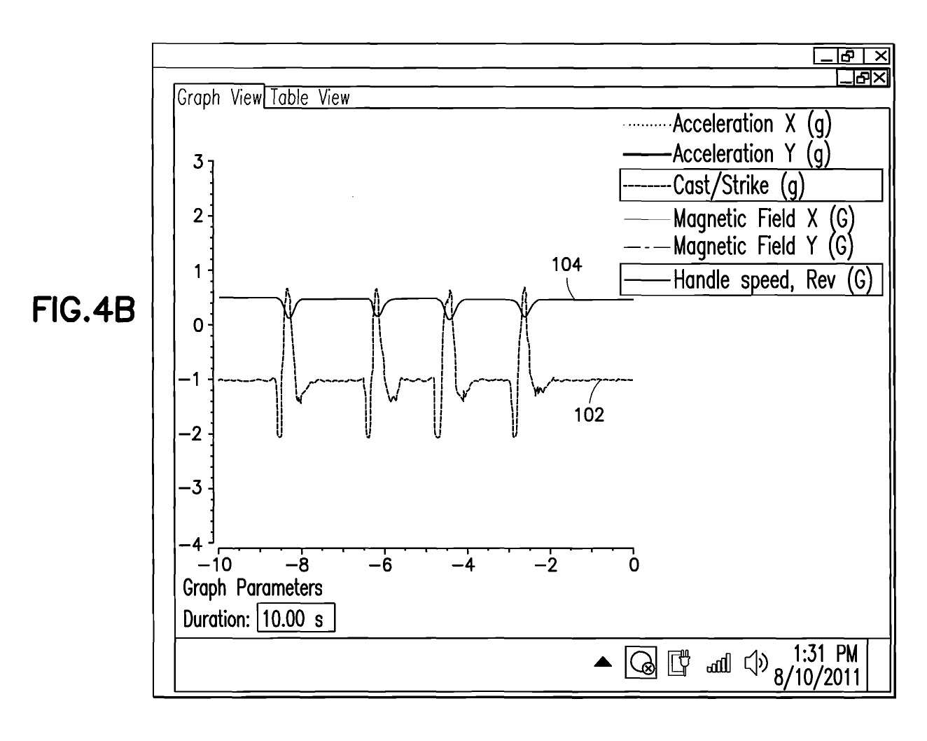

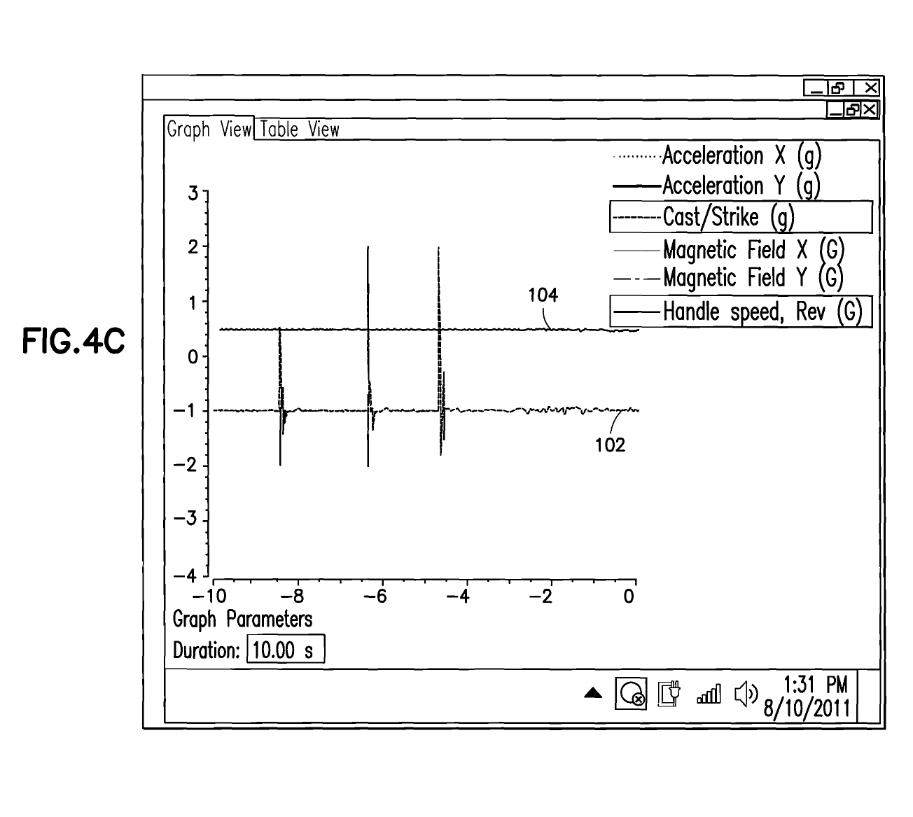

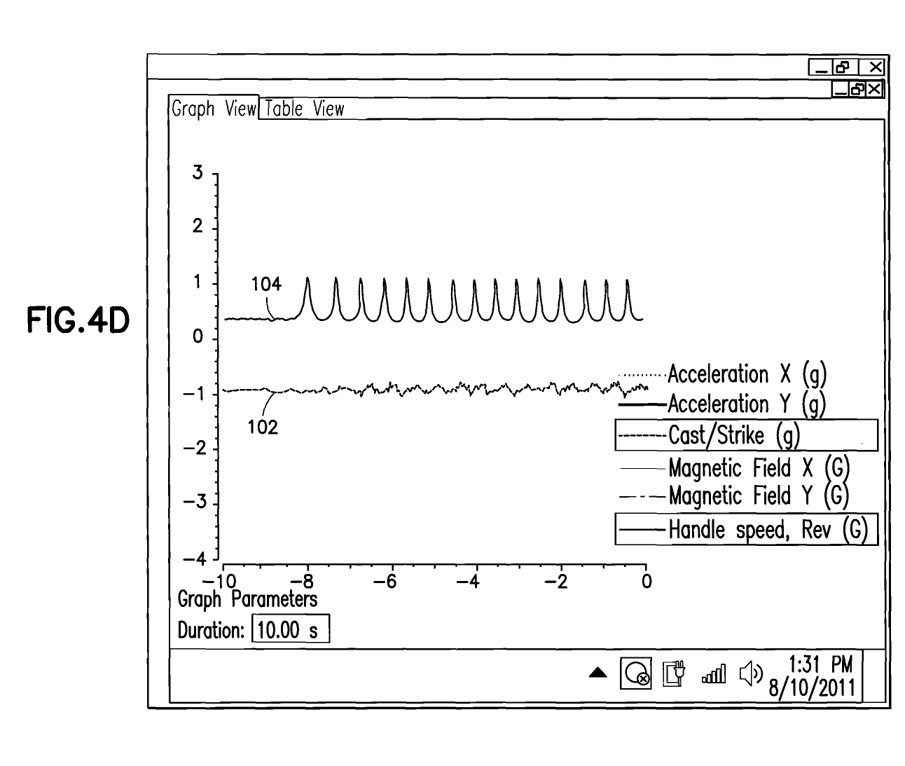

FIGS. 4A, 4B, 4C and 4D are graphic views of some automatically collected illustrative information in accordance with an embodiment of the present invention. As noted above, the real-time, data capturing electronics 22 include, but are not limited to a three-axis accelerometer, optical tachometer, magnetometer and/or digital compass, wired and wireless communication system, memory and rechargeable battery power supply, within the rod, the reel, or removably attachable thereto for detecting movement, movement speed and direction of the rod and reel during use. In the first exemplary embodiment, a three-axis accelerometer, optical tachometer and magnetometer are provided with the fishing reel, and in the second exemplary embodiment, a three-axis accelerometer and magnetometer are provided with the fishing rod, and a magnetic element is provided with the reel. FIG. 4A is a plot 100 of real-time, input signal 102 showing rod acceleration (i.e., movement) data that is communicated by the three axis accelerometer, which can be used to calculate casting, casting distance, and fish-on occurrences, and input signal 104 showing spool or handle movement data that is communicated by the optical tachometer or magnetometer, which can be used to calculate line feed amount and line retrieval rates.

The plot 100 includes a y-axis 106 set to a signal magnitude value, and an x-axis 108 plotting the signal over time. Adjustments to the y-axis increments can be made to accommodate sensors of different amplification, and the x-axis can be set at time increments sufficiently small enough to detect signal transitions. A plurality of input signals can be processed as shown by the drop-down box 110. For example, the signals can include both x-axis and y-axis acceleration signals, cast/strike signal, both x-axis and y-axis magnetic field signals, and handle speed signal. For illustration purposes, the plot 100 includes cast/strike signal 102 showing rod acceleration (i.e., movement) data that is communicated by the three axis accelerometer, which can be used to calculate casting, casting distance, and fish-on occurrences, and handle speed signal 104 showing spool or handle movement data that is communicated by the optical tachometer or magnetometer, which can be used to calculate line feed amount and line retrieval rates. The other input signals are omitted from the plot 100 for clarity.

As seen in the plot 100 of FIG. 4A, where there is no rod movement or reel movement, the signal values 102 and 104 remain constant. However, upon movement of either the rod or the reel, the signal values reflect such movements. FIG. 4B is the plot 100 of real-time, input signal 102 showing rod acceleration (i.e., movement) data that is communicated by the three axis accelerometer indicating four casting motions. Input signal 104 shows spool or handle movement data that is communicated by the optical tachometer or magnetometer indicating four movements of the handle corresponding to casting motions. The magnitude of the signals 104 can be used to determine the type of motion of the spool or handle movement. In this case, the magnitude of the signals 104 indicate handle movement due to rod movement, and not due to rotation. FIG. 4C is the plot 100 of real-time, input signal 102 showing rod acceleration (i.e., movement) data that is communicated by the three axis accelerometer indicating three fish strike occurrences. In this case, the magnitude of the signals 102 indicate rod movement due to a fish strike occurrence, and not due to casting. Input signal 104 shows no spool or handle movement communicated by the optical tachometer or magnetometer indicating no movement of the handle during the period of the three fish strikes. FIG. 4D is the plot 100 of real-time, input signal 104 showing fifteen spool or handle movements communicated by the optical tachometer or magnetometer indicating movement of the handle. In this case, the magnitude of the signals 102 indicate rod movement due to spool or handle movements, and not due to casting or fish strikes.

Returning to FIG. 2, the communication element 25 can automatically obtain the real-time data of FIGS. 4A, 4B, 4C and 4D via wired or wireless communication means such as RF, Bluetooth and infrared communication, and others as specified under the IEEE 802 wireless standards, including but not limited to 802.11 (WiFi, WLAN), 802.15 (WPAN, Bluetooth, ZigBee) and 802.16 (WMAN) from the data capturing electronics 22 including the three-axis accelerometer, optical tachometer, magnetometer and/or digital compass within the rod and reel. The real-time data of FIGS. 4A, 4B, 4C and 4D can be automatically updated and communicated to the communication element 25 continuously and/or at set time intervals, at set distance intervals, or can be automatically updated and communicated to the communication element 25 at the occurrence of a triggering event. The communication element 25 can further receive or capture real-time environmental data (RED) regarding GPS location, date, time, weather conditions, water conditions, moon phase, and tide, and other data (OD) including photographic information with or without geo-tagging and lure information via wired or wireless communication or direct user input, to combine with the data of FIGS. 4A, 4B, 4C and 4D to create data points.

The real-time data of FIGS. 4A, 4B, 4C and 4D is transmitted from the rod and reel to the communication element 25 using the telecommunications system and memory 24 (e.g. radio transmitters and receivers, remote controls, computer networks, network terminals, etc.) which store, buffer and transfer information with or without the use of wires using RF, Bluetooth and infrared communication, and others as specified under the IEEE 802 wireless standards, including but not limited to 802.11 (WiFi, WLAN), 802.15 (WPAN, Bluetooth, ZigBee) and 802.16 (WMAN). Wired communication means can also be used such as USB and Firewire connections. The rechargeable and/or replaceable battery or other power source 32 is provided with the rod and reel to energize the sensors, data collection and the wired or wireless data communication.

As received, the real-time data of FIGS. 4A, 4B, 4C and 4D can be displayed on the communication element 25 or the PC 35 for analysis, troubleshooting and/or setup. For example, the threshold signal value for detecting a strike occurrence can be set at one level for one fishing situation, and set at a second level for a second fishing situation. Further, the display of the real-time data of FIGS. 4A, 4B, 4C and 4D can be provided to troubleshoot the operations of the accelerometer, tachometer and magnetometer.

Such data is monitored continuously, and specific values of each plot can be automatically captured and combined with other data to create a data point. The exemplary embodiments can create new data points continuously and/or at set time intervals, at set distance intervals, at the beginning of each cast, at some interval of each cast, or upon occurrence of a triggering event (i.e., automatic or manual fish-on detection or manual data collection triggering). In the case of trolling or similar technique, a new data point can be automatically created at some time interval, distance interval, or water depth interval. In the case of cast detection triggering the automatic creation of data points at the beginning of each cast, the cast can begin with the opening of the bail in an exemplary spinning reel or the cast can begin with pressing the thumb-button in an exemplary baitcast reel or spincast reel.

As noted above, the equipment use data (EUD) (i.e., the number of casts, casting distance, the direction of the cast, lure depth, lure retrieval speed, and when a fish is caught) is combined with the real-time environmental data (RED) (i.e., GPS location (i.e., latitude, longitude and altitude), date, time, weather conditions, water conditions, moon phase, and tide), and with the other data (OD) (i.e., lure use, fish species and photographic information with or without geo-tagging), to form a data point, and the collection of data points is used to create a digital fishing log which is stored in the communication element 25, PC 35, data storage device 45, or cloud storage/processing 55. Further, prior to accumulation of data in the database, or to periodically supplement the data in the database, existing information such as underwater contour maps, navigational maps and other nautical charts such as those available through the National Oceanic and Atmospheric Administration, can be used to populate the initial database to create an initial digital fishing log.

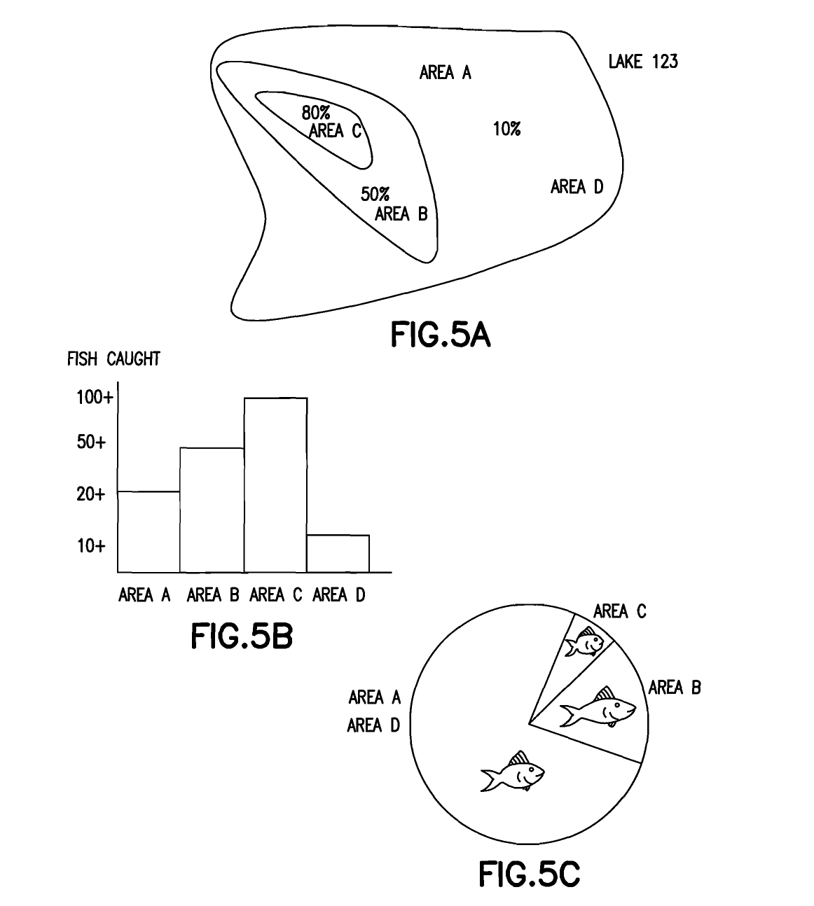

The processing of the automatically collected data (EUD), (RED) and (OD), into such data points can be achieved using a hardware, software, or combined hardware-software program. The exemplary embodiment can comprise computer-readable medium, machine-readable medium, or other non-transitory medium, or web-based software to analyze and format the collected data. The data points can be statistically analyzed to, for example, predict a probability of catching a fish, provide information regarding the use of equipment or other user-controllable variables, given recent, current or expected conditions or other uncontrollable variables. Any suitable analysis tool can be used including but not limited to statistical programming language “S”, and versions of “S” including “R” and S-PLUS”. Still other examples of a suitable analysis tool can be “SPSS Statistics”. FIGS. 5A, 5B and 5C illustrate a number of analysis outputs provided by the exemplary embodiments of the present invention. The outputs of FIGS. 5A, 5B and 5C can be displayed on the communication element 25 or the PC 35 for analysis, troubleshooting and/or setup.

FIG. 5A is a GPS display of a position and a GIS display of the probability of catching a fish by location in lake. The exemplary lake, labeled “123” is shown with mapped areas A, B, C and D. Each of the areas is provided with a label indicating a probability of success (such as 10%, 50% and 80%). Further, an area with a high probability of success can be distinguished by display of a different color from an area with a low probability of success. The control of the communication element 25 can provide the same or additional data in any number of other desirable formats. For example, in a similar fashion, FIG. 5B is a histogram of fish caught by mapped areas A, B, C and D of the exemplary lake 123 that can be displayed on the communication element 25 or the PC 35 for analysis. FIG. 5C is yet another display that can be displayed on the communication element 25 or the PC 35 for analysis, having been narrowed to illustrate the possible species of fish that can be caught by area, and provide fish identification using picture and specie recognition software.

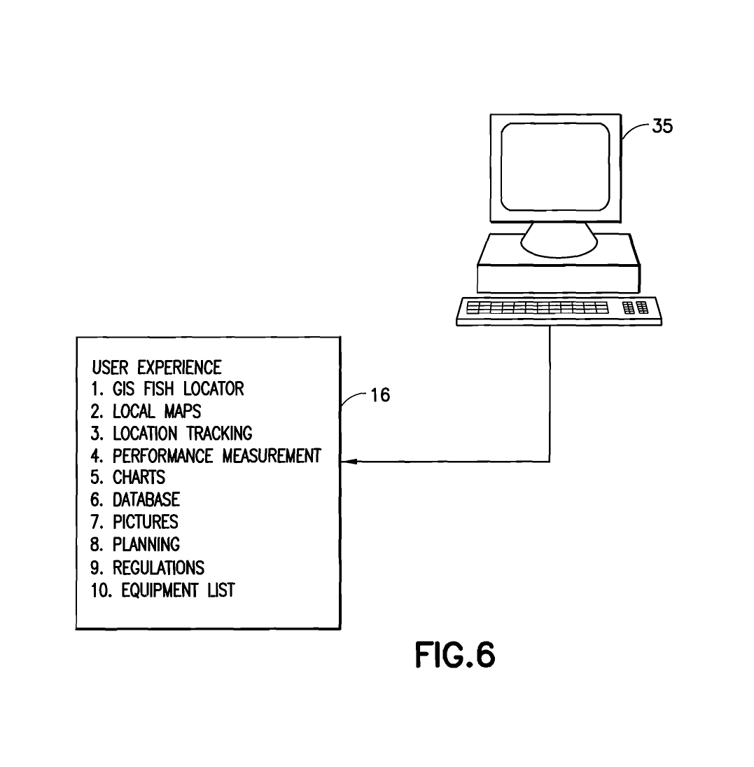

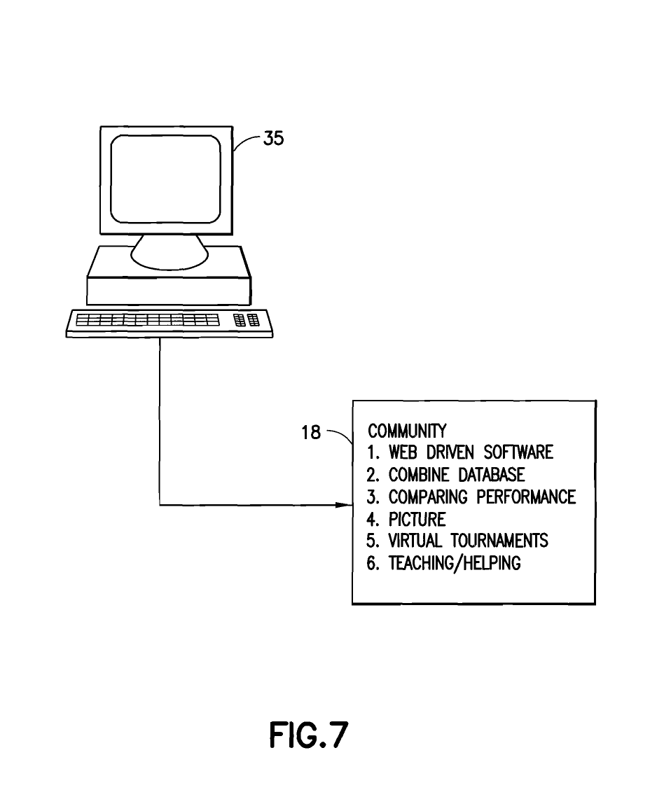

FIGS. 6 and 7 are views of a data processing and output subsystem for translating and formatting the collected information, and exchanging the formatted information between devices in accordance with an embodiment of the present invention. In an exemplary embodiment of the present invention, the automatic collection of the data points forms the database, and the database is statistically analyzed to, for example, predict a probability of catching a fish or provide other information regarding the use of equipment (e.g., user-controllable variables), given the recent, current or expected conditions (e.g., uncontrollable variables).

The database is stored in the communication element 25, PC 35, data storage device 45, or cloud storage/processing 55, and can be accessed and displayed through the communication element 25 or the PC 35. To do so, at least the communication element 25 and the PC 35 comprise a display element and driver to display, for example, but not limited to, the input data of FIGS. 4A, 4B, 4C and 4D, and the output data of FIGS. 5A, 5B and 5C including a GPS display of the current position and a GIS display of the probability of catching a fish by location, wherein a high probability can be distinguished by providing a display with a different color from a low probability, a histogram of fish caught by area, and possible species of fish that can be caught by area, and provide fish identification using picture and specie recognition software. Where the display comprises a touch screen, the display can also provide an input means.

The data points in the database are also used for trip planning, fishing location sequence planning and to prepare maps and directions to locations based upon frequency analysis (including lure, equipment and use information for each location). The data points in the database are also used to calculate performance measurements, such as graphs or charts for comparing current performance against probability information, charts comparing current casting distance against past performance, charts comparing current retrieval rate against past performance, number of fish caught against past performance, and number of fish caught against other anglers' results. The data points in the database are also used to calculate recommended actions, such as line weight and type, rigging and other lure recommendations and retrieval rate recommendations, and expected performance doing so given variables such as changing weather while holding all other variables constant. The data points in the database are also used to identify and calculate expected performance of other bodies of water using, for example GIS information. The data points in the database are also used to calculate equipment information and inventory, including equipment requirements or shopping lists, and where equipment can be obtained relative to a current or expected fishing location.

Still further, additional information can be made readily accessible through the communication element 25 or the PC 35 such as fishing regulations by location, pictures of the past fish caught, and even the creation and exchange of fishing games using the data in the database. That is, the system and method can be applied by a single or multiple users. In the case of multiple users, a plurality of communication elements 25 and PCs 35 can be networked via cloud storage/processing 55 and as specified under the IEEE 802 wireless standards, including but not limited to 802.11 (WiFi, WLAN), 802.15 (WPAN, Bluetooth, ZigBee) and 802.16 (WMAN) or as otherwise known to those skilled in the art such that the data of each can be maintained separately, or can be shared and combined when generating the results and displays described above. To do so, the exemplary embodiments can comprise computer-readable medium, machine-readable medium, or other non-transitory medium, or web-based software which can communicate, share and/or restrict access to data by requesting one or more of a user name and password. A user who wishes to either share data or access data of another, either free or based upon a subscription plan (i.e., providing payment to a provider for access to information, and providing payment to a user for providing or sharing data), can be required to first enter a user name and password at a communication element 25 or PC 35. If the entered user name and password match those stored at the database, the user can share data or access data of another to generate the results and displays described above.

Such combination of data can also be used to facilitate social networking including, but not limited to, the creation of virtual fishing tournaments using the data in the database, performance and result rankings between users, and real-time updates to social networking sites such as Facebook. The users can also share non-data point information, such as personal information and data including posted photos. In each case, the user has the option of making his data available to users and gain access to use the data created by other users.

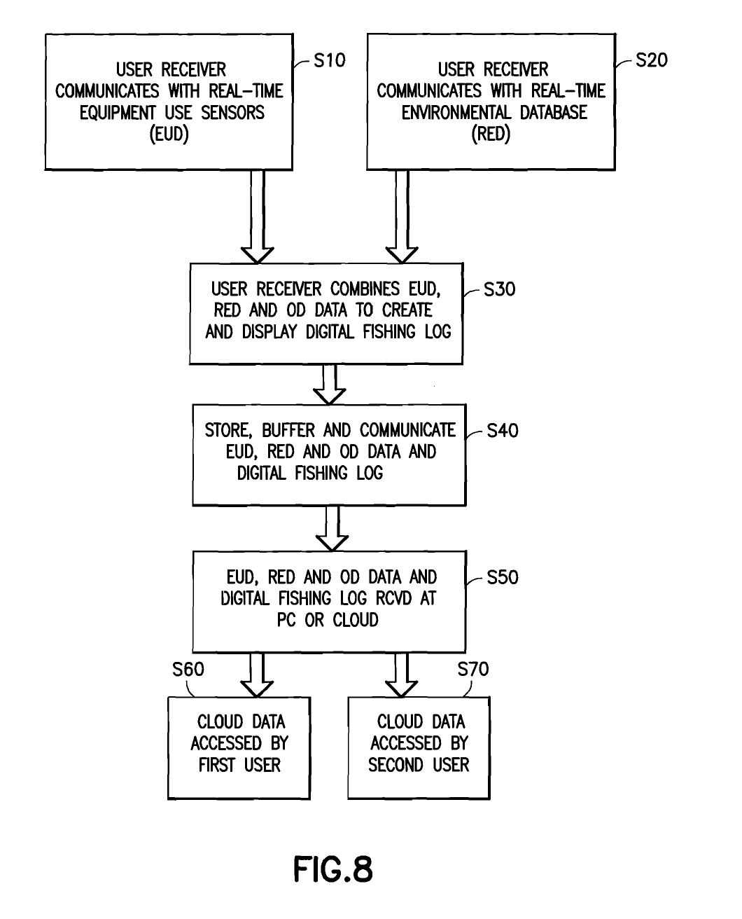

FIG. 8 is a flow chart of an exemplary operation of the automatic fishing data collection and processing system of FIG. 1 in accordance with an embodiment of the present invention. In an exemplary implementation of the embodiments described above, a method for automatically creating a fishing log can be achieved by controlling a first communication element to communicate with data collection subsystems including, for example the plurality of sensors disposed upon one of the rod and reel as described above at step S10 and receive equipment use data (EUD) regarding cast number, casting distance, casting direction, lure retrieval rate and depth, and fish-on condition at the first communication element.

At the same or different time, the first communication element is controlled to communicate with environmental subsystems at step S20 and receive real-time environmental data (RED) regarding GPS location, date, time, location, weather condition, moon phase, water condition, and tide condition at the first communication element. In steps S10 and S20, the first communication element is controlled to communicate with the subsystems continuously, periodically, or at some other points such as the beginning of each cast, at some interval of each cast, or upon occurrence of a triggering event (i.e., automatic of manual fish on detection or manual data collection triggering). In the case of trolling or similar technique, the first communication element is controlled to communicate with the subsystems at some time interval, distance interval, or water depth interval. In the case of cast detection triggering the automatic creation of data points at the beginning of each cast, the cast can begin with the opening of the bail in an exemplary spinning reel or the cast can begin with pressing the thumb-button in an exemplary baitcast reel or spincast reel. At the same or different time, other data (OD) such as lure use, fish species and photographic information can also be received at the first communication element as desired, but is not required for operation of the present invention.

The first communication element combines the equipment use data (EUD) (i.e., the number of casts, casting distance, the direction of the cast, lure depth, lure retrieval speed, and when a fish is caught) with the real-time environmental data (RED) (i.e., GPS location (i.e., latitude, longitude and altitude), date, time, weather conditions, water conditions, moon phase, and tide) and the other data (OD) (i.e., lure use, fish species and photographic information), to form the data points at step S30, and the collection of data points is used to create the digital fishing log. The data points are used to create the digital fishing log at any one or more of the first communication element, personal computer (PC) or cloud storage as described below.

The exemplary embodiments can collect data and create new data points continuously, periodically, or at some other point such as the beginning of each cast, at some interval of each cast, or upon occurrence of a triggering event (i.e., automatic of manual fish on detection or manual data collection triggering). The exemplary embodiments can also create new data points based upon elapsed time, or changes in distance, water depth, water temperature, water clarity, or any number of variables, to tie the data point to a changing variable occurrence. The exemplary embodiments can also create new data points in response to a triggering event as described above, either manually generated, pulse-senor generated, or equipment-sensor generated, to tie the data point to a fish-on occurrence. The exemplary embodiments can also generate data points based on some combination of the above, for example, those tied to a changing variable occurrence (i.e., based upon elapsed time, distance, water depth, water temperature, water clarity) and those tied to a fish-on occurrence.

The data points are then used to create the digital fishing log at any one or more of the first communication element, personal computer (PC) or cloud storage. At step S40, the data and/or fishing log is buffered and communicated from the first communication element to at least one of the personal computer (PC), memory storage device, and cloud storage at step S50. Where preferable to do so, the personal computer (PC) can be used to combine the equipment use data (EUD) with the real-time environmental data (RED) and the other data (OD) to form the data points, and the collection of data points is used to create the digital fishing log. The personal computer (PC) can also be used to re-combine the equipment use data (EUD) with the real-time environmental data (RED) and the other data (OD) in different manners to re-create the digital fishing log. In this case, the data and/or fishing log is buffered and communicated from the personal computer (PC) to cloud storage.

Once the data and/or fishing log is communicated to cloud storage, it can be stored for later access by the user, or shared with other users. In an exemplary embodiment, the digital fishing log is communicated at step S60 to the user or to a second communication element of another user at step S70. The user can either share data or access their own data or data of another of another, either free or based upon a subscription plan.

The exemplary embodiments described above provide for the automatic collection of data and creation of fishing log entries based thereon, as soon as the fish is caught or at the moment of data recognition, based upon accurate measurement techniques. The resulting fishing log permits the easy manipulation and formatting of data contained therein, the sharing of information with other anglers, and the incorporation of information from other anglers. The system and method enhances the angler's skill and experience by continuously monitoring and automatically capturing how the angler uses equipment (EUD) relative to real-time environmental information (RED), translating and formatting the collected information, and exchanging the formatted information between any number of digital devices and device users. The collected data is analyzed and formatted into a user-friendly database to provide recommendations on how, where, and when to use equipment, thereby increasing the probability of catching fish and allowing the angler to repeat successful fishing experiences.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A fishing system having a fishing reel with a spool to store fishing line and a mechanism to release and retrieve said fishing line, and a fishing rod to facilitate a cast and retrieval of said fishing line and to couple with said fishing reel, comprising:
a first sensor to detect each cast;
a second sensor to measure a casting distance of fishing line released from said reel and detect a retrieval rate of said fishing line;
a third sensor to measure a casting direction,
wherein said second sensor measures said casting distance and said third sensor measures said casting direction in response to a triggering event; and
a transmitter that transmits said data of said first sensor, second sensor and third sensor to a receiver.

2. The fishing system of claim 1, further comprising a pulse monitoring sensor to detect a user pulse rate and based thereon, generate said triggering event.

3. The fishing system of claim 1, further comprising a user-accessible switch to generate said triggering event when activated by said user.

4. The fishing system of claim 1, further comprising a sensor to detect at least one of a vibration level in said rod, and a strain level in at least one of said rod and said fishing line, and based thereon, generate said triggering event.

5. The fishing system of claim 1, further comprising a user receiver that receives said data of said first sensor, second sensor and third sensor from said transmitter.

6. The fishing system of claim 5, wherein said user receiver comprises at least one of a cellular telephone, a programmable cellular telephone, a computer, a receiver associated with a retransmitter, a smartphone, and a personal digital assistant (PDA).

7. The fishing system of claim 5, wherein said user receiver is configured to determine one or more of a date, time, location, weather condition, moon phase, water condition, and tide condition.

8. The fishing system of claim 7, wherein said user receiver communicates,
said one or more of date, time, location, weather condition, moon phase, water condition, and tide condition information, and
said data of said first sensor regarding detected cast, said data of said second sensor regarding casting distance and retrieval rate, and said data of said third sensor regarding casting direction,
to at least one of a computer, data storage device, and internet-accessible cloud storage and processing system.

9. The fishing system of claim 8, wherein said at least one of said user receiver and computer determines,
a position of a fishing line end using said data of said second sensor regarding casting distance and retrieval rate, and said data of said third sensor regarding casting direction.

10. The fishing system of claim 9, wherein said at least one of said user receiver and computer combines,
said data regarding date, time, location, weather condition, moon phase, water condition, and tide condition, and,
said data of said position of said fishing line end, at each triggering event, to create a plurality of data points, and,
creates a digital fishing log using said plurality of data points and communicates said digital fishing log to an internet-accessible cloud storage and processing system.

11. The fishing system of claim 8, wherein said at least one of said user receiver and computer combines,
said data regarding date, time, location, weather condition, moon phase, water condition, and tide condition, and,
said data of said first sensor regarding detected cast, said data of said second sensor regarding casting distance and retrieval rate, and said data of said third sensor regarding casting direction, at each triggering event, to create a plurality of data points, and,
creates a digital fishing log using said plurality of data points and communicates said digital fishing log to an internet-accessible cloud storage and processing system.

12. The fishing system of claim 8, wherein said at least one of said user receiver and computer combines,
said data regarding date, time, location, weather condition, moon phase, water condition, and tide condition, and,
said data of said first sensor regarding detected cast, said data of said second sensor regarding casting distance and retrieval rate and said data of said third sensor regarding casting direction, to create a plurality of data points, and,
creates a digital fishing log using said plurality of data points and communicates said digital fishing log to an internet-accessible cloud storage and processing system.

13. The fishing system of claim 12, wherein said at least one of said user receiver, computer and internet-accessible cloud storage and processing system,
communicates said digital fishing log with at least a second user receiver, wherein said second user receiver comprises at least one of a cellular telephone, a programmable cellular telephone, a computer, a receiver associated with a retransmitter, a smartphone, and a personal digital assistant (PDA).

14. The fishing system of claim 1, wherein at least one of said first sensor, second senor and third sensor is integral with said rod.

15. The fishing system of claim 1, wherein at least one of said first sensor, second senor and third sensor is insertable within a space provided by said rod.

16. The fishing system of claim 1, wherein at least one of said first sensor, second senor and third sensor is attachable to said rod.

17. A method for automatically creating a fishing log, comprising the steps of:
controlling a first user receiver to communicate with a data collection subsystem comprising a plurality of sensors disposed upon at least one of a rod and reel, and receive data regarding cast number, casting distance, casting direction, retrieval rate of fishing line, vibration level and tension level;
controlling said first user receiver to communicate with an environmental subsystem and receive data regarding one or more of a date, time, location, weather condition, moon phase, water condition, and tide condition;
controlling said first user receiver to communicate said data regarding cast number, casting distance, casting direction, retrieval rate of fishing line, vibration level and tension level, and date, time, location, weather condition, moon phase, water condition, and tide condition, to at least one of a computer, data storage device, and internet-accessible cloud storage and processing system; and
controlling said at least one of said first user receiver and said computer to combine said data regarding cast number, casting distance, casting direction, retrieval rate of fishing line, vibration level and tension level, and data regarding date, time, location, weather condition, moon phase, water condition, and tide condition to form a plurality of data points, and use a collection of data points to create a digital fishing log and communicate said digital fishing log to an internet-accessible cloud storage and processing system.

18. The method of claim 17, further comprising the steps of:
controlling a sensor to generate a triggering event and in response thereto, measure said casting distance and measure said casting direction to determine a location of a fishing line end in response to said triggering event.

19. The method of claim 18, further comprising the steps of:
controlling at least one of said first user receiver and said computer to combine,
said data regarding date, time, location, weather condition, moon phase, water condition, and tide condition, and,
said data of said position, at each triggering event, to create said plurality of data points and use a collection of data points to create a digital fishing log and communicate said digital fishing log to an internet-accessible cloud storage and processing system.

20. The method of claim 17, further comprising the steps of:
controlling said at least one of said first user receiver and said computer to communicate said digital fishing log with at least a second user receiver, wherein said first user receiver and said second user receiver comprise at least one of a cellular telephone, a programmable cellular telephone, a computer, a receiver associated with a retransmitter, a smartphone, and a personal digital assistant (PDA).

21. A system for automatically creating a digital fishing log, comprising:
a processor coupled to a memory and transmitter, wherein said processor is programmed to automatically create a fishing log by:
communicating with a data collection subsystem comprising a plurality of sensors disposed upon at least one of a rod and reel and receive data regarding cast number, casting distance, casting direction, retrieval rate of fishing line, vibration level and tension level;
communicating with an environmental subsystem and receive data regarding one or more of a date, time, location, weather condition, moon phase, water condition, and tide condition; and
combining said data regarding cast number, casting distance, casting direction, retrieval rate of fishing line, vibration level and tension level, and data regarding date, time, location, weather condition, moon phase, water condition, and tide condition to form a plurality of data points, and use a collection of data points to create a digital fishing log and communicate said digital fishing log to an internet-accessible cloud storage and processing system.

22. The system of claim 21, wherein said processor is configured to communicate said digital fishing log with at least a second processor, wherein said first and second processor comprise at least one of a cellular telephone, a programmable cellular telephone, a computer, a receiver associated with a retransmitter, a smartphone, and a personal digital assistant (PDA).

23. A non-transitory computer-readable storage medium with an executable program stored thereon, wherein the program performs the following steps to:
control a processor to communicate with a data collection subsystem comprising a plurality of sensors disposed upon at least one of a rod and reel, and receive data regarding cast number, casting distance, casting direction, retrieval rate of fishing line, vibration level and tension level;
control a processor to communicate with an environmental subsystem and receive data regarding one or more of a date, time, location, weather condition, moon phase, water condition, and tide condition;
control a processor to communicate said data regarding cast number, casting distance, casting direction, retrieval rate of fishing line, vibration level and tension level, and date, time, location, weather condition, moon phase, water condition, and tide condition, to at least one of a computer, data storage device, and internet-accessible cloud storage and processing system; and
control at least one of said processor and said computer to combine said data regarding cast number, casting distance, casting direction, retrieval rate of fishing line, vibration level and tension level, and data regarding date, time, location, weather condition, moon phase, water condition, and tide condition to form a plurality of data points, and use a collection of data points to create a digital fishing log and communicate said digital fishing log to an internet-accessible cloud storage and processing system.

24. The storage medium of claim 23, wherein the program performs the additional steps to:
generate a triggering event and in response thereto, measure said casting distance and measure said casting direction to determine a location of a fishing line end in response to said triggering event.

25. The storage medium of claim 24, wherein the program performs the additional steps to:
control said at least one of said processor and said computer to combine,
said data regarding date, time, location, weather condition, moon phase, water condition, and tide condition, and,
said data of said position of said fishing line end, at each triggering event, to create said plurality of data points and use a collection of data points to create a digital fishing log and communicate said digital fishing log to an internet-accessible cloud storage and processing system.

26. The storage medium of claim 23, wherein the program performs the additional steps of:
controlling said at least one of said processor and said computer to communicate said digital fishing log with at least a second processor, wherein said first and second processor comprise at least one of a cellular telephone, a programmable cellular telephone, a computer, a receiver associated with a retransmitter, a smartphone, and a personal digital assistant (PDA).

27. A fishing reel with a spool to store fishing line and a mechanism to release and retrieve said fishing line, comprising:
a first sensor to detect each cast;
a second sensor to measure a casting distance of fishing line released from said reel and detect a retrieval rate of said fishing line, wherein said second sensor measures said casting distance in response to a triggering event; and
a transmitter that transmits said data of said first sensor and said second sensor to a user receiver.

28. The fishing reel of claim 27, further comprising a pulse monitoring sensor to detect a user pulse rate and based thereon, generate said triggering event.

29. The fishing reel of claim 27, further comprising a user-accessible switch to generate said triggering event when activated by said user.

30. The fishing reel of claim 27, further comprising at least one sensor to detect a strain level in said fishing line, and based thereon, generate said triggering event.

31. The fishing reel of claim 27, further comprising a user receiver that receives said data of said first sensor and said second sensor from said transmitter.

32. The fishing reel of claim 31, wherein said user receiver comprises at least one of a cellular telephone, a programmable cellular telephone, a computer, a receiver associated with a retransmitter, a smartphone, and a personal digital assistant (PDA).

33. The fishing reel of claim 31, wherein said user receiver is configured to determine one or more of a date, time, location, weather condition, moon phase, water condition, and tide condition.

34. The fishing reel of claim 33, wherein said user receiver communicates,
said one or more of date, time, location, weather condition, moon phase, water condition, and tide condition information, and
said data of said first sensor regarding detected activation of said reel, and said data of said second sensor regarding casting distance and retrieval rate,
to at least one of a computer, data storage device, and internet-accessible cloud storage and processing system.

35. The fishing reel of claim 34, wherein said at least one of said user receiver and said computer determines a position of a fishing line end using said data of said second sensor regarding casting distance and retrieval rate.

36. The fishing reel of claim 35, wherein said at least one of said user receiver and said computer combines,
said data regarding date, time, location, weather condition, moon phase, water condition, and tide condition, and,
said data of said position, at each triggering event, to create a plurality of data points, and,
use a collection of data points to create a digital fishing log and communicate said digital fishing log to an internet-accessible cloud storage and processing system.

37. The fishing reel of claim 34, wherein said at least one of said user receiver and said computer combines,
said data regarding date, time, location, weather condition, moon phase, water condition, and tide condition, and,
said data of said first sensor regarding detected activation of said reel and said data of said second sensor regarding casting distance and retrieval rate, at each triggering event, to create a plurality of data points, and,
use a collection of data points to create a digital fishing log and communicate said digital fishing log to an internet-accessible cloud storage and processing system.

38. The fishing reel of claim 34, wherein said at least one of said user receiver and said computer combines,
said data regarding date, time, location, weather condition, moon phase, water condition, and tide condition, and,
said data of said first sensor regarding detected activation of said reel and said data of said second sensor regarding casting distance and retrieval rate, to create a plurality of data points, and,
use a collection of data points to create a digital fishing log and communicate said digital fishing log to an internet-accessible cloud storage and processing system.

39. The fishing reel of claim 38, wherein said at least one of said user receiver and said computer,
communicates said digital fishing log with at least a second user receiver, wherein said second user receiver comprises at least one of a cellular telephone, a programmable cellular telephone, a computer, a receiver associated with a retransmitter, a smartphone, and a personal digital assistant (PDA).

40. A fishing rod, comprising:
a first sensor to detect each cast;
a second sensor to measure a casting distance of fishing line released and detect a retrieval rate of said fishing line;
a third sensor to measure a casting direction,
wherein said second sensor measures said casting distance and said third sensor measures said casting direction in response to a triggering event; and
a transmitter that transmits said data of said first sensor, second sensor and third sensor to a receiver.

41. The fishing rod of claim 40, further comprising a pulse monitoring sensor to detect a user pulse rate and based thereon, generate said triggering event.

42. The fishing rod of claim 40, further comprising a user-accessible switch to generate said triggering event when activated by said user.

43. The fishing rod of claim 40, further comprising a sensor to detect at least one of a vibration level in said rod, and a strain level in at least one of said rod and said fishing line, and based thereon, generate said triggering event.

44. The fishing rod of claim 40, further comprising a user receiver that receives said data of said first sensor, second sensor and third sensor from said transmitter.

45. The fishing rod of claim 44, wherein said user receiver comprises at least one of a cellular telephone, a programmable cellular telephone, a computer, a receiver associated with a retransmitter, a smartphone, and a personal digital assistant (PDA).

46. The fishing rod of claim 44, wherein said user receiver is configured to determine one or more of a date, time, location, weather condition, moon phase, water condition, and tide condition.

47. The fishing rod of claim 46, wherein said user receiver communicates,
said one or more of date, time, location, weather condition, moon phase, water condition, and tide condition information, and
said data of said first sensor regarding detected cast, said data of said second sensor regarding casting distance and retrieval rate, and said data of said third sensor regarding casting direction,
to at least one of a computer, data storage device, and internet-accessible cloud storage and processing system.

48. The fishing rod of claim 47, wherein said at least one of said user receiver and said computer determines a position of a fishing line end using said data of said second sensor regarding casting distance and retrieval rate, and said data of said third sensor regarding casting direction.

49. The fishing rod of claim 47, wherein said at least one of said user receiver and said computer combines,
said data regarding date, time, location, weather condition, moon phase, water condition, and tide condition, and,
said data of said position, at each triggering event, to create a plurality of data points, and,
use a collection of data points to create a digital fishing log and communicate said digital fishing log to an internet-accessible cloud storage and processing system.

50. The fishing rod of claim 47, wherein said at least one of said user receiver and said computer combines,
said data regarding date, time, location, weather condition, moon phase, water condition, and tide condition, and,
said data of said first sensor regarding detected cast, said data of said second sensor regarding casting distance and retrieval rate, and said data of said third sensor regarding casting direction, at each triggering event, to create a plurality of data points, and,
use a collection of data points to create a digital fishing log and communicate said digital fishing log to an internet-accessible cloud storage and processing system.

51. The fishing rod of claim 47, wherein said at least one of said user receiver and said computer combines,
said data regarding date, time, location, weather condition, moon phase, water condition, and tide condition, and,
said data of said first sensor regarding detected cast, said data of said second sensor regarding casting distance and retrieval rate and said data of said third sensor regarding casting direction, to create a plurality of data points, and,
use a collection of data points to create a digital fishing log and communicate said digital fishing log to an internet-accessible cloud storage and processing system.

52. The fishing rod of claim 51, wherein said at least one of said user receiver and said computer,
communicates said digital fishing log with at least a second user receiver, wherein said second user receiver comprises at least one of a cellular telephone, a programmable cellular telephone, a computer, a receiver associated with a retransmitter, a smartphone, and a personal digital assistant (PDA).
